(19) United States
(12) Patent Application Publication
(10) Pub. No.: US 2009/0273917 A1
(43) Pub. Date: Nov. 5, 2009

(54) LIGHTING DEVICE

(76) Inventor: Johannes Gerhardus Bartelink, Johannesburg (ZA)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/162,265

(22) PCT Filed: Jan. 24, 2007
(86) PCT No.: PCT/ZA2007/000009

§ 371 Date: Oct. 24, 2008

(30) Foreign Application Priority Data
Jan. 27, 2006 (ZA) 2006/00784
Nov. 3, 2006 (ZA) 2006/9193

(51) Int. Cl. F21V 19/04

(52) U.S. Cl. 362/20

(57) ABSTRACT

A lighting device which includes a body with at least two contacts, an energy storage device which is connected to the contacts and which stores electrical energy when the contacts are connected to an electrical power source, a first light source, and a switch arrangement which is responsive to disconnection of the power source from the contacts and which then switches to connect the first light source to the energy storage device.

### BACKGROUND OF THE INVENTION

This invention relates to a lighting device which is suited for providing a degree of lighting under emergency conditions.

A power failure in a dwelling, office, factory or other location or building, which takes place at night or under conditions of low ambient lighting, can have serious consequences. For example a person in a factory may be operating machinery when power fails and may be confronted with dangerous obstacles in the darkness. If the power failure or interruption is due to the operation of a circuit breaker at a distribution board or panel then, ideally, a person should automatically be given sufficient lighting to enable the person to find the circuit breaker in the dark. If the power interruption is due to a general power failure then, again, lighting is desirable to enable a person to carry out necessary functions e.g. go to bed, bath, eat or the like. These examples are merely illustrative, not limiting, and are given to show different kinds of problems which can arise when a constant supply of electricity, which usually is taken for granted, is interrupted leaving a person in the dark or under low ambient-light conditions.

Stand-by lighting systems and uninterruptible power systems are available but these are expensive for generally they are designed to provide a substantial degree of light or power under emergency conditions.

The invention is concerned with an inexpensive lighting device which can at least partly address the aforementioned situation.

### SUMMARY OF THE INVENTION

The invention provides a lighting device which includes a body with at least two contacts, an energy storage device which is connected to the contacts and which stores electrical energy when the contacts are connected to an electrical power source, a first light source, and a switch arrangement which is responsive to disconnection of the power source from the contacts and which then switches to connect the first light source to the energy storage device.

The energy storage device may be a long-life, low voltage miniature battery or similar apparatus.

The power source to which the first and second contacts are connected may be a mains alternating current supply and the lighting device may include a rectifier to produce a direct current for charging the energy storage device.

The switch arrangement may switch automatically between a first mode in which the first light source is disconnected from the energy storage device when the contacts are connected to the power source and a second mode in which the first light source is connected to the energy storage device when the power source is not connected to the first and second contacts.

The body may be of any suitable shape or size. In one form of the invention the body is configured to be connected to a lamp e.g. a ceiling or table lamp. If a switch to the lamp is remote from the lamp then the switch may be bridged by a capacitor in parallel to the switch. This allows the energy storage device to be charged when the switch is open and, if the power supply is interrupted, the first light source is energised. The switch and the bridging capacitor may form part of, and be incorporated into, the lighting device. The first light source, the energy storage device and the switch arrangement may be supported on or in the body either directly or indirectly. For example these components may be supported on a printed circuit board or other substrate which, in turn, is mounted to the body.

At least part of the body may be translucent to allow light from the first light source, when energised, to pass through the body. Alternatively, although less preferably, the first light source may be positioned so that at least part thereof is outside the body. In another variation the body includes a window which is made from a transparent material through which light emitted by the first light source can pass. In another version the body includes an aperture or opening through which light from the first light source can travel.

The switch arrangement preferably includes a transistor or similar semiconductive device which is off while the energy storage device is being charged and which automatically is turned on when the power supply is no longer impressed across the contacts, or when the power supply is interrupted.

The lighting device may include a second light source which is energised when the energy storage device is being charged and which is not energised when the first light source is connected to the energy storage device.

Preferably each light source is a semiconductor device e.g. a light emitting diode (LED), as opposed to an incandescent or gas discharge device. An LED is easily switched and is capable of emitting light at an acceptable level of illumination, in an energy-efficient manner.

The contacts may comprise, or be connected to, terminals which facilitate a connection to electrical leads, either in line or in parallel.

A voltage reduction arrangement may be incorporated in the lighting device to produce a suitable voltage which is rectified and used for charging the energy storage device.

The lighting device can be provided in various forms. Primary considerations in this respect however are at least the following:
1. the device should be inexpensive;
2. the device should be small and unobtrusive and, ideally, should blend with or be incorporated in a standard or conventional electrical or other fitting; and
3. when activated the device should emit light for a relatively long time, of the order of several hours. A high light intensity level is not required for the device is not intended to act as a complete substitute for a failed, conventional light source but, instead, to provide a degree of low-level lighting in emergency situations.

In one form of the invention the lighting device is adapted to be fitted to a socket outlet. This could be a single or multiplug outlet. For the device to be effective the socket outlet is directly connected to a mains supply or, otherwise, is connected by a switch to the mains supply. In the latter case the switch is then preferably bridged by a capacitor, in the manner which has been described.

The lighting device may be wholly contained in a cover or lid for a plug which, when engaged with a base of the plug, automatically places a circuit of the lighting device into electrical contact with a power supply.

In one preferred form of the invention the lighting device is in the form of an electrical plug and the contacts comprise, or are electrically connected to, respective pins which extend from the body for engagement with corresponding sockets in an electrical outlet.

The body may form a body for the electrical plug and may include a base to which the pins are mounted and a cover, which may be at least partly translucent, which is removably engageable with the base. As noted the cover preferably houses components of the electrical device.

The plug may include connectors for connecting the pins to electrical leads—this allows the plug to be used as a conventional plug to supply electricity to an appliance.

In another preferred embodiment the lighting device is attached to a cover of a light switch socket outlet.

### BRIEF DESCRIPTION OF THE DRAWINGS

The invention is further described by way of examples with reference to the accompanying drawings in which:

FIG. 1 illustrates a physical construction of a lighting device according to one form of the invention;

FIG. 2 illustrates a typical electrical circuit inside the lighting device of FIG. 1;

FIG. 3 illustrates a modified electrical circuit;

FIGS. 4 and 5 are exploded views of a modified form of the lighting device shown in FIG. 1;

FIG. 6 has plan views of a base and a cover of the lighting device in FIGS. 4 and 5;

FIG. 7 is a cross sectional side view of the lighting device in FIGS. 4, 5 and 6, when assembled; and

FIGS. 8 and 9 show other versions of the invention.

### DESCRIPTION OF PREFERRED EMBODIMENTS

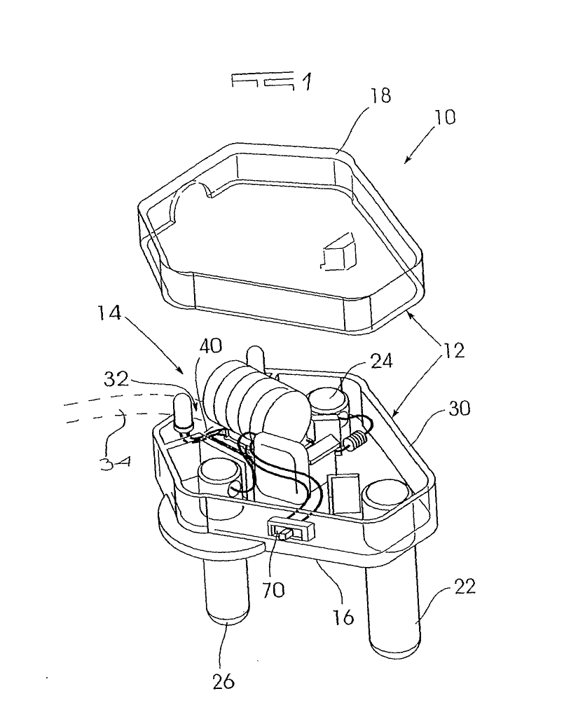

FIG. 1 of the accompanying drawings illustrates a lighting device 10 according to the invention which includes an electrical plug 12 and a lighting circuit 14. The electrical plug 12 is substantially conventional. The plug includes a body which is formed from a base 16 and a cover or lid 18 which is removably engageable with the base using any appropriate technique known in the art. Generally the base 16 and cover 18 are triangular in outline (this is illustrative only) and when these components are engaged with one another, to form the body of the plug, they define a volume inside the body. At least the cover 18 is made from a translucent or transparent material.

Three electrical terminals or contacts, formed by conductive pins, are mounted to and extend from an underside of the base. These terminals comprise an earth pin 22, a live pin 24 and a neutral pin 26.

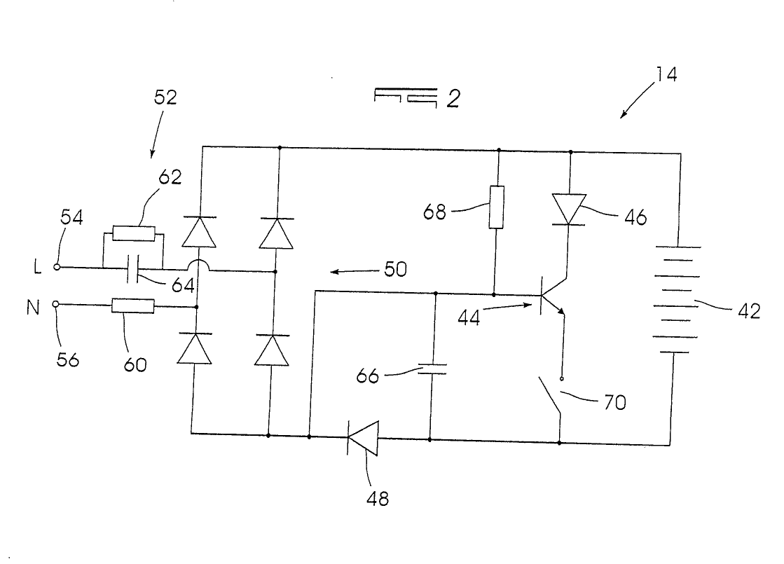

A small wall 30 extends around a periphery of the base and an opening 32 is formed in the wall roughly midway between the pins 24 and 26. In use of the plug electrical leads 34 extend from an external appliance (not shown) through the opening and are connected respectively to the live pin 24 and the neutral pin 26. In most instances an earth wire, not shown, is connected to the earth pin 22. The lighting circuit 14, which is connected between the live and neutral pins 24 and 26, includes a small printed circuit board 40 and a plurality of electrical components, shown in FIG. 2, which are mounted on the board.

The lighting circuit 14 includes a miniature, low-voltage, long life rechargeable battery such as a nickel metal hydride battery 42, a transistor 44, a high efficiency light emitting diode 46 which when energised emits white light, a relatively low powered light emitting diode 48 which when energised emits red light, a bridge rectifier arrangement 50 and a voltage reduction circuit 52 which also functions as a constant current source. The circuit 14 has contacts 54 and 56 respectively which are connected to the pins 24 and 26 respectively.

If electrical power is applied to the pins 24 and 26 i.e. if the plug is inserted into an electrical outlet socket then a device connected to the plug, by the electrical leads referred to, is operable.

The main supply voltage is effectively reduced by the circuit 52 and the reduced voltage is applied to the bridge rectifier 50. A small current, the value of which is determined by resistors 60 and 62 and a capacitor 64, flows to the battery 42 and charges the battery. The current flows through the light emitting diode 48 and energises this device which emits red light at a low intensity level. This diode is forward biased and the base-emitter junction of the transistor 44 is reverse biased. The transistor is thereby automatically held in an off state. No current flows through the light emitting diode 46 to the collector of the transistor.

If the power supply is interrupted or fails, for whatever reason, then no current flows into the circuit via the contacts 54 and 56. The reverse bias which previously existed across the base-emitter junction of the transistor is removed. A capacitor 66 is charged to a value determined by its capacitance and the value of a resistor 68 and the transistor is forward biased and turns on. Current then flows through the high efficiency light emitting diode 46. Thus, almost immediately after the power supply to the terminals is interrupted, the diode 46 is energised. The light which is emitted by this diode is substantial and is transmitted through the transparent cover 18. Depending on the size of the battery 42 and the efficiency and characteristics of the diode 46 light will be emitted for a period of several hours. The lighting intensity established by the diode is sufficient to allow a user, with ease, to find his way in the dark. Also, if the plug is removed from its socket, the plug can be used as a portable light source.

If the power supply is restored to the terminals then the light emitting diode 46 is turned off as the transistor is turned off and the light emitting diode 48 is again energised to indicate that the power supply is present and that the battery 42 is being recharged.

It is possible to incorporate a small switch 70 between the battery and the emitter. The switch is user-actuable and can be used to turn the transistor 44 and hence the light emitting diode 46 on or off as required when no power is applied to the circuit 14. The switch could be mounted at a convenient position e.g. on a side of the wall 30—see FIG. 1.

The resistor 68 could be a light dependent device whose resistance changes with ambient lighting. The resistor is positioned so that it is not exposed to light from the diode 46. If a power failure occurs when the level of ambient lighting is high the transistor 44 is held off. The transistor is only turned on when the level of ambient lighting drops and there is a power failure. This feature helps to maximize the period for which light will be available from the battery.

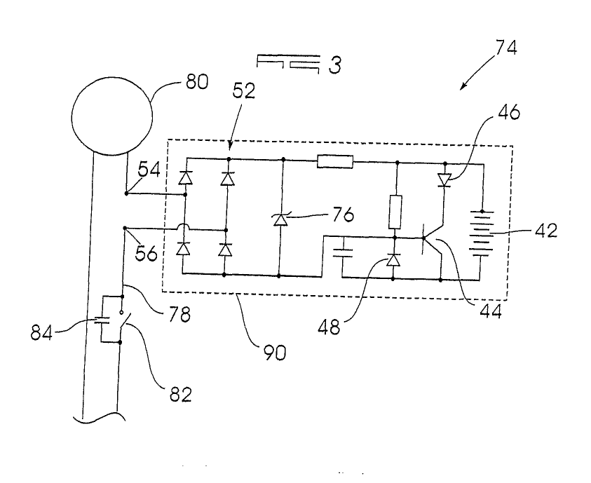

FIG. 3 shows a circuit 74 which is a variation of the circuit of FIG. 2. Components in FIG. 3 which are the same as components in FIG. 2 bear like reference numerals. Only differences between the two circuits are explained.

The contacts 54 and 56 are connected in series in a conductor 78 of a main supply to a lamp 80. The conductor has a series switch 82 which is bridged by a capacitor 84. If the switch 82 is open a small current flows through the capacitor. This is rectified by the bridge 52 and used to charge the battery 42. The current has no discernable effect on the lamp 80. If the switch 82 is closed the charging process still takes place. However if the power supply is interrupted or fails, for whatever reason, then no current flows into the circuit 74. The reverse bias across the base-emitter junction of the transistor 44 is removed and the transistor is forward biased and turns on. Current then flows through the high efficiency light emitting diode 46 which is then energised. The circuit thus operates in a similar way to the circuit 14.

The switch 82 and the capacitor 84 can be included in the body of the device to provide an integral unit, or can be separate therefrom. The body of the lighting device is represented by a dotted block 90 and preferably is constituted by a housing of a conventional electrical mechanism such as a socket outlet, a light switch, or the like. This approach allows the lighting device to be provided in an unobtrusive way, at low cost, at locations at which electrical appliances are used and, consequently, an electrical supply is already available and can be used, without further cost, to charge the battery.

A small user-actuable switch can be connected between the battery and the emitter to turn the transistor, and hence the light emitting diode 46, on or off as required.

A light dependent resistor or similar component can be used with the lighting device to ensure that the transistor is only turned on when the level of ambient lighting drops and there is a power failure.

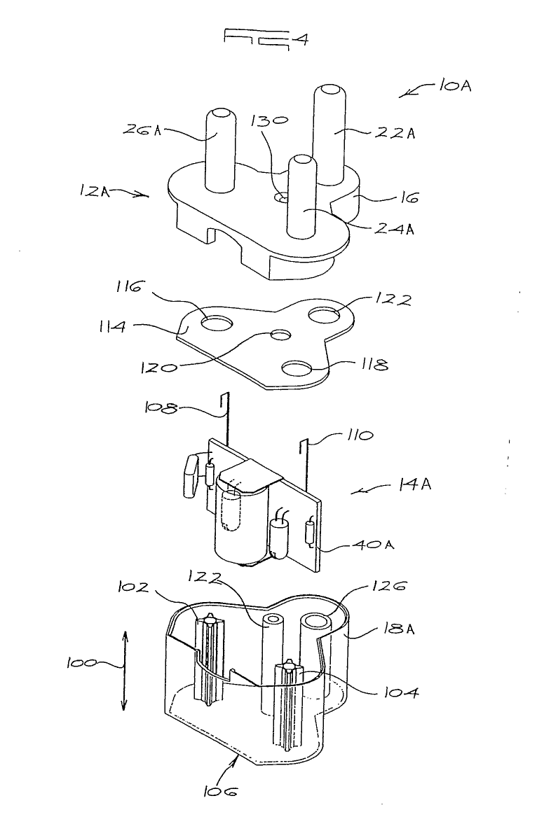

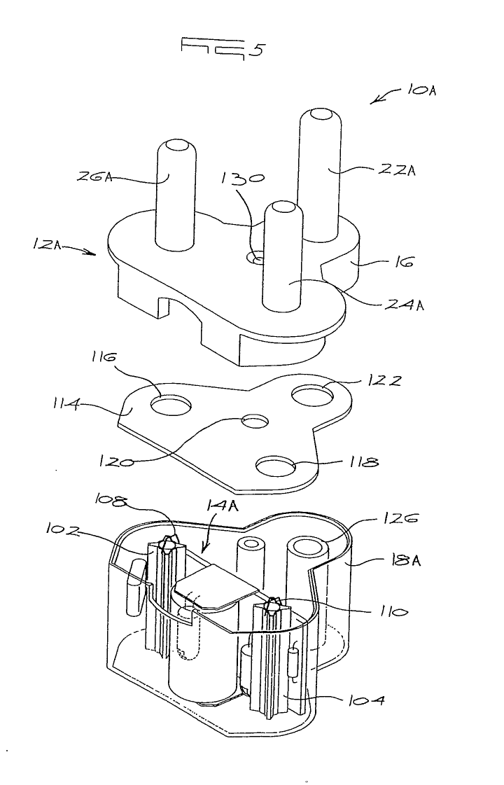

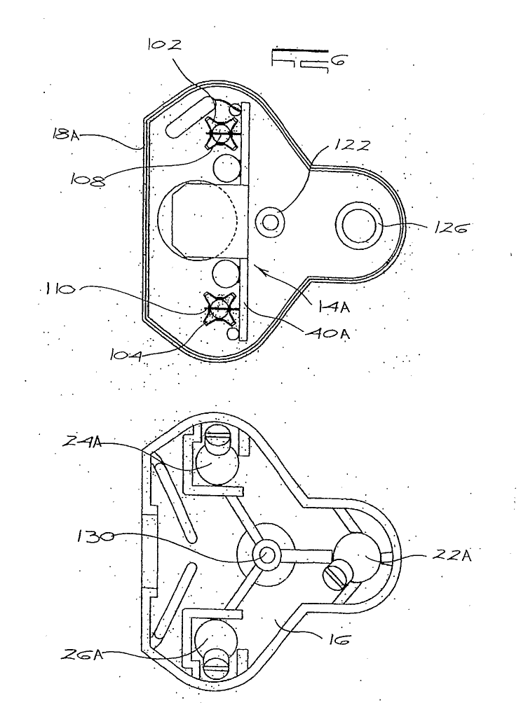

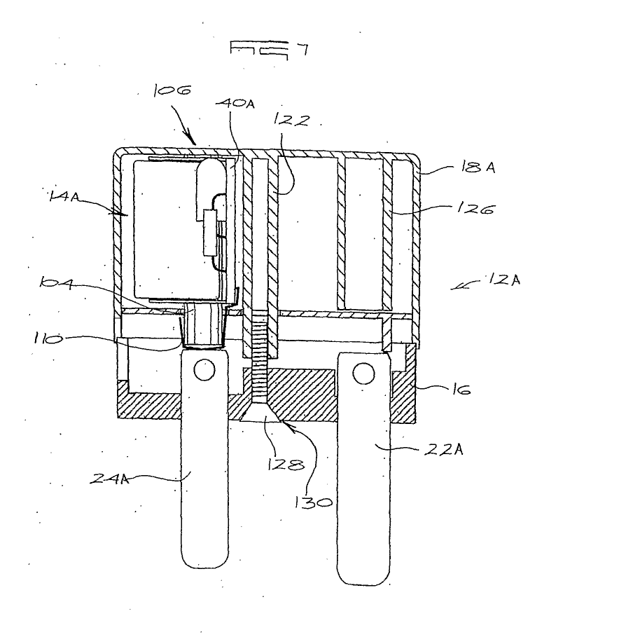

FIGS. 4 and 5 are exploded views of a lighting device 10A which is a modified form of the arrangement shown in FIG. 1. FIG. 6 has plan views of a base and cover of the device, while FIG. 7 is a cross sectional side view of the device, when assembled.

The lighting device 10 has a base 16 to which the lighting circuit 14 is mounted. By way of contrast the lighting device 10A has a base 16 which, for all practical purposes, is conventional. The lighting circuit, designated 14A, is secured, not to the base, but to a cover designated 18A.

The cover is made from a transparent plastics material and has a cross sectional shape which is substantially conventional. However in order to accommodate the circuit 14A the cover has an increased depth, designated 100. Two narrow columns 102 and 104 respectively extend upwardly from a planar end plate 106 of the cover. These columns are cross-shaped in cross section.

The circuit 14A is mounted to a printed circuit board 40A which is designed to fit adjacent the columns 102 and 104. Leads 108 and 110 are bared and correspond respectively to the contacts 54 and 56 shown in FIG. 2.

When the circuit 14A is inserted into the cover, a leading end of the board 40A comes to rest on an inner surface of the end plate 106. The leads 108 and 110 are shaped to overlie ends of the columns 102 and 104. A retaining plate 114 is then engaged with the cover. The plate is shaped to fit closely inside the cover and has two holes 116 and 118 through which the columns 102 and 104 respectively extend. A third hole 120 in the retaining plate provides passage for a fixing tubular formation 122 on an inner surface of the end plate 106. A fourth hole 122 allows a tubular pin 126 to be positioned close to an end of an earth terminal 22A.

The lighting device 10A thus is constituted by an electrical plug 12A and the lighting circuit 14A which is fully contained in the cover 18A. The plug 12A is substantially conventional and electrical leads, not shown, can be attached to the earth pin 22A, a live pin 24A and a neutral pin 26A in a conventional manner. When the cover is engaged with the base the leads 108 and 110 automatically are brought into electrical contact with opposed ends of the live and neutral pins. The plug 12A is used in a normal way and the lighting device can be engaged with the plug or disengaged from the plug, as necessary, to make electrical connections to the plug pins in a conventional manner. During this process the lighting device is not in any way interfered with. Once the cover is engaged with the base a fastening screw 128 is passed through a central hole 130 in the base 16 and is engaged with a bore of the formation 122 to retain the cover engaged with the base (see FIG. 7).

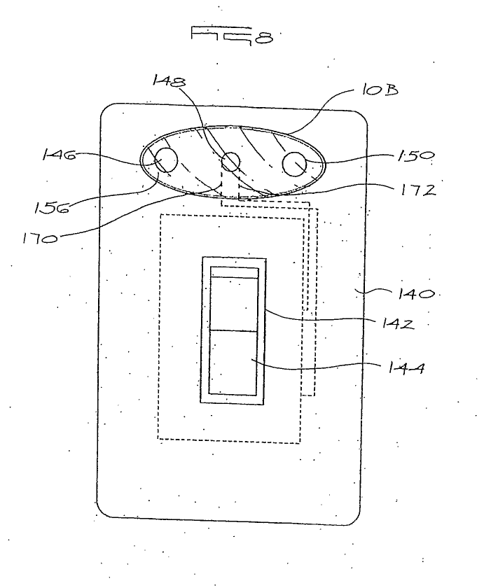

FIG. 8 shows another embodiment of the invention. In this case a lighting device 10B is adapted to be fixed to a cover plate 140 of a light switch. The cover plate has an aperture 142 for an electrical switch 144.

Three small holes 146, 148 and 150 are formed through the cover plate at a suitable location. The lighting device 10B, generally of the kind described hereinbefore, has a transparent housing 156 which contains an electrical circuit which is similar to the circuit shown in FIG. 3. If a neutral lead is present at the light switch the circuit could be similar to the circuit shown in FIG. 2. Two leads 170 and 172 extend from the housing and pass through the central hole 148 in the cover plate.

The housing has two flexible clips which are engageable with a spring action with the holes 146 and 150 respectively. When this is done the housing is securely fixed to an outer surface of the cover plate. The leads are connected across the switch 144 in the manner shown in FIG. 3.

The arrangement shown in FIG. 8 functions in the same way as what has been described hereinbefore for, if there is a power failure, the battery in the lighting circuit, charged while power is not interrupted, is automatically turned on to energise a light emitting diode or other high efficiency low light level emitting device which shines through the housing 156.

The arrangement shown in FIG. 8 can be retrofitted to existing installations or can be provided as new equipment when a building is being wired. It is convenient to provide the lighting device in conjunction with a cover plate for a light switch for emergency lighting can then be provided at a relatively low cost.

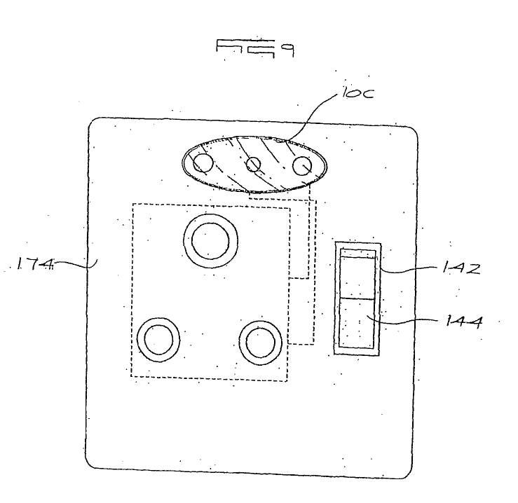

FIG. 9 shows a lighting arrangement 10C, which is similar to that in FIG. 8, provided on a cover plate 174 of a socket outlet. The arrangement has a circuit of the kind shown in FIG. 2 connected to live and neutral wires in the outlet.

The lighting device can take on different forms, for example:
(a) as a light box that is connected to and fitted before an in-line light switch of the type which is often found on lounge lights or bedside lights;
(b) as a small adapter, which fits into a normal light fitting, e.g. a ceiling light, between the light and the fitting. When the power fails the LED is energised and as it is fitted high up it will light up the immediate area as well;
(c) in a small plastic housing which is clipped onto an end of a multiplug adapter. In this way the adapter will light up (be illuminated) when the power fails. All the components of the device can be contained within the housing which can be made partly or wholly from a clear or translucent plastic material which protects the components and which allows light from the light emitting diodes to be transmitted through the material; and
(d) the device can be incorporated in a wall-mounted socket outlet with the diode 46 at least partly external to a cover plate of the socket, or behind a transparent window in the cover plate.

In all forms the invention has particular benefits in that it provides a lighting device which is small and of compact construction, highly efficient and of relatively low cost. The body in which the lighting device is incorporated or otherwise associated with can take on various forms and guises. Particularly important in this respect is the ability to provide the lighting device in combination with a conventional electrical appliance such as a plug, a socket, a light switch, or the like. Due to the low cost of the lighting device it is possible for a household, factory, hospital or the like to make use of a large number of the devices, each of which incorporates the electrical circuit. All of the light sources will automatically be energised upon failure of a mains power supply.

1-22. (canceled)

23. A lighting device comprising:
an electrical plug with a body having at least two pins extending from the body for engagement with corresponding sockets in an electrical outlet and which include formations for engagement with externally extending electrical leads;
an electrical circuit having an energy storage device connected to the pins which stores electrical energy when the pins are connected to an electrical power source;
a first light source; and
a switch arrangement responsive to disconnection of the power source from the pins and which then switches to connect the light source to the energy storage device.

24. The lighting device according to claim 23, wherein the body comprises a base, and a transparent cover in which the energy storage device, first light source and switch arrangement are located.

25. The lighting device according to claim 23, wherein the base is engageable with the cover to place the pins in electrical contact with the electrical circuit.

26. The lighting device according to claim 23, in which the energy storage device is a long-life, low voltage miniature battery.

27. The lighting device according to claim 23, further comprising a rectifier to produce a direct current for charging the energy storage device.

28. The lighting device according to claim 23, wherein the switch arrangement switches automatically between a first mode in which the first light source is disconnected from the energy storage device when the contacts are connected to the power source and a second mode in which the first light source is connected to the energy storage device when the power source is not connected to the first and second contacts.

29. The lighting device according to claim 23, wherein at least part of the body is translucent to allow light from the first light source, when energised, to pass through the body.

30. The lighting device according to claim 23, wherein the first light source is positioned so that at least part thereof is outside of the body.

31. The lighting device according to claim 23, wherein the switch arrangement includes a semiconductive device which is off while the energy storage device is being charged and which is automatically turned on when the power supply is off.

32. The lighting device according to claim 23, further comprising a second light source which is energised when the energy storage device is being charged and which is not energised when the first light source is connected to the energy storage device.

33. The lighting device according to claim 23, further comprising at least one of:
(a) a light sensor which prevents the first light source from being energised if the ambient light level is good; and
(b) a switch to control the connection of the first light source to the energy storage device.
